(19) United States
(12) Patent Application Publication
(10) Pub. No.: US 2015/0181340 A1
(43) Pub. Date: Jun. 25, 2015

(54) THERMOPLASTIC RESIN FOAM FILM AND METHOD FOR PRODUCING SAME

(71) Applicant: KANEKA CORPORATION, Osaka-shi, Osaka (JP)

(72) Inventor: Koji Noda, Tokyo (JP)

(73) Assignee: KANEKA CORPORATION, Osaka-shi, Osaka (JP)

(21) Appl. No.: 14/414,720

(22) PCT Filed: Jul. 24, 2013
(86) PCT No.: PCT/JP2013/070018

§ 371 Date: Jan. 14, 2015

(30) Foreign Application Priority Data
Jul. 26, 2012 (JP) 2012-165703

(51) Int. Cl. H04R 7/02; B32B 15/20; B32B 15/04; B29C 67/00; B32B 5/18

(52) U.S. Cl. CPC H04R 7/02; B29C 67/0011; B32B 5/18; B32B 15/046; B32B 15/20; B29K 2079/085

(57) ABSTRACT

Provided is a thermoplastic resin foam film consisting substantially of a thermoplastic resin. The thermoplastic resin is a poly(meth)acrylimide resin, and the thermoplastic resin foam film has a density of 30 to 500 kg/m³, an average cell diameter of 2 to 500 μm, and a thickness of 0.05 to 1.0 mm. The lightweight, thin thermoplastic resin foam film having high heat resistance and high compressive resistance can be provided. By laminating an aluminum foil or the like, a multilayer foam film having high rigidity can be provided.

### TECHNICAL FIELD

The present invention relates to a thermoplastic resin foam film and a method for producing the thermoplastic resin foam film.

### BACKGROUND ART

As mobile communication terminals such as cell phones have been downsized and had more functions, there is an increasing demand for lightweight, thin members having high heat resistance and high rigidity. Such a member can be produced from a single material, but is preferably has a multilayer structure including surface layers and a core because the structure can satisfy both lightweight and rigidity at a high level. There is thus a demand for lightweight, thin foams that have heat resistance and high compressive strength and are suited for the core.

The thin foam film is exemplified by low-density foams including a polyurethane resin, and the low-density foams are used as sealing members for the display of cell phones and other parts. Patent Document 1 discloses a polyurethane foam having a thickness of 0.3 to 13 mm. However, such a foam is provided between two parts and deforms so as to leave no clearance, and thus is unsuited as the core for multilayer structures.

Patent Document 2 discloses a multilayer foam sheet including a polyphenylene ether resin and a polystyrene resin and having a large heat shrinkage factor in a particular direction and also discloses a foam film having a thickness of 0.25 to 0.5 mm. However, the foam film is prepared by drawing with a large force in an extrusion direction in order to increase the heat shrinkage factor, thus contains cells greatly flattened in the thickness direction, and consequently has poor compressive strength.

Patent Document 3 discloses a technique of producing a foam including a poly(meth)acrylimide resin. Foams relating to the technique are marketed under the trade name ROHACELL (registered trademark). The commercially-available foams, ROHACELL (registered trademark) unfortunately have a thickness of 1 mm or more, and there is no thermoplastic resin foam film having a thickness of 0.1 mm to 0.5 mm, for example.

In addition, the foam films disclosed in Patent Documents 1 and 2 are directly produced by foaming of a predetermined resin. Such a method is limited to produce a much lighter, thinner foam film having higher expansion ratio.

To cut a thermoplastic resin foam, methods with a band knife such as a moving saw blade or knife blade have been adopted, for example. Patent Document 4 discloses a method for cutting the surface of a foam with a knife blade. Patent Document 4 describes cutting work without breaking bubbles on the surface of a foam but describes no production of foam films. Patent Document 4 also discloses cutting with a knife blade as the cutting method and exemplifies a band saw as the knife blade. When the method is used to produce a thin foam film, freeplay (flexure) in tension of the knife blade unfortunately causes uneven thickness, and thus a foam film having high thickness precision cannot be obtained. Furthermore, a thick welded part generated when a knife blade is processed into a circular shape comes into contact with a cutting surface to leave linear cutting traces. A planer is also exemplified for cutting, but a foam cut by the method yields small pieces. Thus, a foam film having a desired thickness cannot be obtained.

### CITATION LIST

### Patent Literatures

Patent Document 1: JP-A No. 2007-44972

Patent Document 2: JP-A No. H02-151429

Patent Document 3: JP-A No. 2007-513213

Patent Document 4: JP-A No. 2002-86577

### SUMMARY OF INVENTION

### Technical Problem

An object of the present invention is to provide a lightweight, thin thermoplastic resin foam film having high heat resistance and high compressive resistance. Another object of the present invention is to provide a multilayer foam film having high rigidity by laminating the foam film with an aluminum foil or the like. Another object of the present invention is to provide a method for producing a thermoplastic resin foam film by cutting a thermoplastic resin foam.

### Solution to Problem

As a result of intensive studies to solve the problems, the inventors of the present invention have found that by using a poly(meth)acrylimide resin as a thermoplastic resin and focusing particular characteristics of foam films, an obtained thermoplastic resin foam film can have high compressive resistance and high heat resistance and have lighter weight and smaller thickness than those of conventional films and that a structure including the thermoplastic resin foam film has higher rigidity than that of conventional structures. That is, the aspects of the present invention are as below.

[1] A thermoplastic resin foam film consists substantially of a thermoplastic resin, the thermoplastic resin is a poly(meth)acrylimide resin, and the thermoplastic resin foam film has a density of 30 to 500 kg/m³, an average cell diameter of 2 to 500 μm, and a thickness of 0.05 to 1.0 mm.

[2] A multilayer foam film produced by laminating an aluminum foil on at least one side of the thermoplastic resin foam film according to the aspect [1].

[3] A loudspeaker diaphragm includes the thermoplastic resin foam film according to the aspect [1] or the multilayer foam film according to the aspect [2].

[4] A method for producing the thermoplastic resin foam film according to the aspect [1] includes a cutting step of cutting a thermoplastic resin foam consisting substantially of a poly(meth)acrylimide resin with a cutting blade. In the cutting step, at least one of the thermoplastic resin foam and the cutting blade is reciprocated, the thermoplastic resin foam slides on the cutting blade on at least one path of an outward path and a return path, and thus the thermoplastic resin foam is intermittently cut to yield a flake consisting substantially of the poly(meth)acrylimide resin.

[5] The method for producing the thermoplastic resin foam film according to the aspect [4] further includes a flattening step of flattening the flake while the flake is heated at a temperature [° C.] that is not lower than a temperature 100 [° C.] lower than a glass transition temperature (Tg) [° C.] of the poly(meth)acrylimide resin and is not higher than the Tg.

### Advantageous Effects of Invention

The present invention can provide the lightweight, thin thermoplastic resin foam film having high heat resistance and high compressive resistance. The multilayer foam film produced by laminating the thermoplastic resin foam film with an aluminum foil or the like has high rigidity and is suitable as loudspeaker diaphragms, for example. The production method of the present invention can provide a thermoplastic resin foam film having high thickness precision.

### BRIEF DESCRIPTION OF THE DRAWING

FIG. 1 is a schematic view showing an illustrative embodiment of a cutting machine used in a cutting step of a production method pertaining to the present invention.

### DESCRIPTION OF EMBODIMENTS

The thermoplastic resin foam film pertaining to the present invention is a thermoplastic foam film consisting substantially of a thermoplastic resin. The thermoplastic resin is a poly(meth)acrylimide resin, and the thermoplastic resin foam film has a density of 30 to 500 kg/m³, an average cell diameter of 2 to 500 μm, and a thickness of 0.05 to 1.0 mm.

The thermoplastic resin foam film pertaining to the present invention has a density of 30 to 500 kg/m³. The lower limit of the density may be 30 kg/m³ or more and is preferably 40 kg/m³ or more and more preferably 55 kg/m³ or more. The upper limit of the density may be 500 kg/m³ or less and is preferably 400 kg/m³ or less and more preferably 300 kg/m³ or less. If the density is less than 30 kg/m³, a good foam film is unlikely to be obtained. In such a condition, the film formation is likely to be difficult particularly in the cutting step of the production method described later. If the density is more than 500 kg/m³, the film may have poor lightweight properties.

The thermoplastic resin foam film pertaining to the present invention has an average cell diameter of 2 to 500 μm. The lower limit of the average cell diameter may be 2 μm or more and is preferably 5 μm or more and more preferably 10 μm or more. The upper limit of the average cell diameter may be 500 μm or less and is preferably 300 μm or less and more preferably 260 μm or less. If the average cell diameter is less than 2 μm, the foam film has a substantially small expansion ratio and thus has a larger density. Such a film is likely to have poor lightweight properties. If the average cell diameter is more than 500 μm, a good foam film is unlikely to be obtained. In such a condition, cells are broken particularly in the cutting step of the production method described later, and thus the film formation is likely to be difficult.

The thermoplastic resin foam film pertaining to the present invention has a thickness of 0.05 to 1.0 mm. The lower limit of the thickness may be 0.05 mm or more and is preferably 0.07 mm or more and more preferably 0.1 mm or more. The upper limit of the thickness may be 1.0 mm or less and is preferably 0.7 mm or less and more preferably 0.5 mm or less. If a thermoplastic resin foam film having a thickness of less than 0.05 mm is used to produce a multilayer foam film, the multilayer foam film may have poor rigidity. If the thickness is more than 1.0 mm, the use of the thermoplastic resin foam film in a small space may be limited.

When the thermoplastic resin foam film is used for speakers as described later, the thermoplastic resin foam film preferably has a small difference between the maximum thickness and the minimum thickness in terms of uniform acoustic characteristics.

The thermoplastic resin foam film pertaining to the present invention consists substantially of a thermoplastic resin, and the thermoplastic resin is preferably a poly(meth)acrylimide resin. In other words, the thermoplastic resin foam film pertaining to the present invention is composed of a resin composition consisting substantially of a poly(meth)acrylimide resin. By using the poly(meth)acrylimide resin as the thermoplastic resin as described above, a thermoplastic resin foam film having high heat resistance can be obtained. Such a foam film can contain cells each having substantially a uniform structure, can entirely provide uniform performances, and can have high compressive resistance.

The poly(meth)acrylimide resin used in the present invention can be the poly(meth)acrylimide resin constituting the poly(meth)acrylimide foam produced by foaming the foamable cross-linked polymer described in Patent Document 3, for example. The poly(meth)acrylimide foam described in Patent Document 3 is marketed under the trade name ROHACELL (registered trademark). Of the foams of ROHACELL (registered trademark), foams having an average cell diameter of 10 to 260 μm can be preferably used, and the foams having such an average cell diameter are marketed under the product numbers, RC71RIST, RC71HF, RC71RIMA, and RC110HP, for example.

In the present invention, “consisting substantially of a thermoplastic resin” and “consisting substantially of a poly(meth)acrylimide resin” mean that any component can be contained in addition to the poly(meth)acrylimide resin to an extent not to interfere with the functions of the thermoplastic resin foam film finally obtained.

The thermoplastic resin foam film pertaining to the present invention as described above can be produced by a method including the following step.

In other words, the method includes a cutting step of cutting a previously prepared thermoplastic resin foam consisting substantially of a poly(meth)acrylimide resin with a cutting blade. In the cutting step, at least one of the thermoplastic resin foam and the cutting blade is reciprocated, the thermoplastic resin foam slides on the cutting blade on at least one path of the outward path and the return path, and thus the thermoplastic resin foam is intermittently cut to yield a flake consisting substantially of the poly(meth)acrylimide resin as the thermoplastic resin foam film.

In the present invention, “a thermoplastic resin foam sliding on a cutting blade” means that the thermoplastic resin foam moves relative to the cutting blade while the thermoplastic resin foam is in contact with the cutting blade where the moving direction of the reciprocation is not parallel with the blade line direction of the cutting blade but forms a predetermined angle with the blade line direction. Such movement starts cutting by bringing a certain face of the thermoplastic resin foam having a predetermined stereostructure into contact with the cutting blade. The blade line of the cutting blade comes into contact with the foam so as to form a predetermined angle with the reciprocation direction, then the cutting blade moves relative to the foam while cutting the foam, and consequently a flake can be obtained from the foam.

As described above, in the cutting step of the production method of the present invention, at least one of the thermoplastic resin foam and the cutting blade is reciprocated, and the thermoplastic resin foam slides on the cutting blade on at least one path of the outward path and the return path.

Specific examples of the cutting step include a step (i) of fixing a predetermined thermoplastic resin foam and cutting the foam with a reciprocating blade, a step (ii) of fixing a thermoplastic resin foam to a frame capable of reciprocating on rails and cutting the foam with a fixed blade, and a combination step (iii) of them. The thermoplastic resin foam film obtained by such a step can have a surface with higher smoothness and can have higher thickness precision around the center of the film. A band knife such as a moving saw blade or knife blade can be used as the cutting blade but is inferior in terms of surface smoothness or thickness precision.

Of the cutting steps, the step (ii) will be described with reference to drawings.

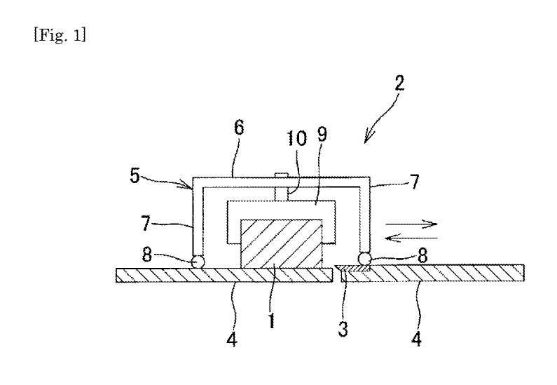

In the cutting step (ii), a cutting machine as shown in FIG. 1 can be used for the reciprocation of a thermoplastic resin foam to yield a flake. In FIG. 1, parts indicated by signs 1, 3, and 4 are shown as sectional views.

A cutting machine 2 shown in FIG. 1 includes a cutting table 4 fixing a cutting blade 3 and a frame 5 capable of reciprocation along rails (not shown in the drawing) provided on the top face of the cutting table. The frame 5 reciprocates in the arrow direction in the drawing. The frame 5 includes a fixing base 6 for fixing a thermoplastic resin foam 1 to the frame 5, legs 7 supporting the fixing base 6 above the cutting table 4, and pulleys 8 (four pulleys in the example) for sliding the frame 5 along the rails on the cutting table 4. In addition, the fixing base 6 of the frame 5 includes a gripper 9 for gripping the thermoplastic resin foam 1 and fixing the foam to the fixing base 6 and an adjuster 10 for adjusting the thickness of a flake.

In the example, the blade edge (the left end of sign 3 in FIG. 1) of the cutting blade 3 is located at a slightly upper position of the left part of the cutting table 4 in the drawing and is placed in a manner that the blade edge faces the thermoplastic resin foam 1.

The angle between the blade line of the cutting blade 3 and the reciprocating direction (cutting direction on the cutting face) of the thermoplastic resin foam 1 is not particularly limited, but the angle (bias angle) between the cutting blade line on the cutting face and the line orthogonal to the cutting direction is preferably 5 to 85°. In this case, when the thermoplastic resin foam 1 comes into contact with the cutting blade 3, the cutting face of the thermoplastic resin foam 1 is not parallel but forms an angle with the blade line of the cutting blade 3, and can first come into contact with blade line at a point. Such a configuration is likely to prevent the thermoplastic resin foam from tearing at the time of cutting.

The reciprocation of the thermoplastic resin foam or the cutting blade in the production method pertaining to the present invention includes, in addition to complete reciprocation on the axis, movement of the reciprocation in combination with a slight up-and-down movement, for example, by connecting one of the thermoplastic resin foam and the cutting blade to a crank gear. Such a combination movement enables cutting while the blade edge of the cutting blade is slightly pulled when the cutting blade comes into contact with the thermoplastic resin foam, and thus can make a smoother surface.

The adjuster 10 for adjusting the thickness of a flake may have any configuration. The adjuster 10 may include a mechanism of continuing to apply a constant load to the thermoplastic resin foam 1 or a mechanism capable of feeding a constant amount of the thermoplastic resin foam 1 for every cutting. Examples of the former mechanism include, but are not limited to, a mechanism of applying a predetermined pressure by an elastic body or the like to the thermoplastic resin foam 1 through the gripper 9. Examples of the latter mechanism include a mechanism of adjusting the distance between the gripper 9 and the blade line of the cutting blade 3 to a predetermined height, and a known mechanism can be appropriately adopted. The adjuster 10 preferably includes the latter mechanism capable of adjusting the feed amount of the thermoplastic resin foam 1 to a predetermined amount because the mechanism achieves high thickness precision at the edge of a foam film to provide a large usable area.

In the production method pertaining to the present invention, the thermoplastic resin foam preferably has a density of 30 to 500 kg/m³. The lower limit of the density is preferably 30 kg/m³ or more, more preferably 40 kg/m³ or more, and even more preferably 55 kg/m³ or more. The upper limit of the density is preferably 500 kg/m³ or less, more preferably 400 kg/m³ or less, and even more preferably 300 kg/m³ or less. If having a density of less than 30 kg/m³, the thermoplastic resin foam may interfere with the thickness precision. If having a density of more than 500 kg/m³, the thermoplastic resin foam may cause cracks in a foam film at the time of cutting. The thermoplastic resin foam may have any structure that can be subjected to the cutting step and is not a film. Examples of the structure include a cubic shape, a rectangular solid shape, a column shape, and an elliptical column shape. Such a thermoplastic resin foam is available as ROHACELL (registered trademark) specifically described above.

In the present invention, the flake immediately after the cutting step can be used without any treatment as the thermoplastic resin foam film pertaining to the present invention, but a flake prepared by cutting the thermoplastic resin foam has curls just like wood shavings and is difficult to handle. To address this problem, the flake obtained in the cutting step is preferably flattened (flattening step) while the flake is heated at a temperature [° C.] that is not lower than a temperature 100 [° C.] lower than a glass transition temperature (Tg) [° C.] of the poly(meth)acrylimide resin constituting the flake and is not higher than the Tg. Here, the flattening with heat means compression under a low pressure on a flat surface with heat, for example, ironing a flake or placing a flake interposed between two flat plates in an oven.

If the heating temperature is lower than a temperature 100° C. lower than Tg, the curls may be insufficiently removed. If the heating temperature is higher than Tg, the foam film may further expand or may be broken, for example, to have a lower thickness precision.

In the present invention, the glass transition temperature (Tg) of the poly(meth)acrylimide resin can be determined by differential scanning calorimetry (DSC), for example. In other words, 1 to 10 mg of a sample is heated from 40° C. to 250° C. at a rate of 10° C./min; the temperature is maintained for 5 minutes; the temperature is next reduced from 250° C. to 40° C. at a rate of 10° C./min; the temperature is maintained for 5 minutes; and the temperature is increased from 40° C. to 250° C. at a rate of 10° C./min once again. From a inflection point in the obtained chart, the glass transition temperature (Tg) can be determined.

In the flattening step, the pressure to compress the flake is preferably 0.1 MPa or less, at which the foam film is not broken.

The flake after the cutting step and the flattening step can be suitably used without any treatment for various purposes as the thermoplastic resin foam film pertaining to the present invention.

By laminating an aluminum foil on at least one side of the thermoplastic resin foam film, a multilayer foam film having higher rigidity can be obtained.

In the multilayer foam film of the present invention, the aluminum foil to be laminated on the thermoplastic resin foam film preferably has a thickness of 0.005 to 0.12 mm and more preferably has a thickness of 0.01 to 0.05 mm. An aluminum foil having a thickness of less than 0.005 mm may have wrinkles at the time of laminating, and an aluminum foil having a thickness of more than 0.12 mm may impair the lightweight properties.

In the multilayer foam film of the present invention, the method of laminating the thermoplastic resin foam film with the aluminum foil is not limited and can be methods including adhesives, pressure-sensitive adhesives, heat sealing, and other means. The laminating is preferably achieved with adhesives or pressure-sensitive adhesives in terms of productivity and the thickness precision of a multilayer composite. The adhesive used for the laminating is preferably solvent-free adhesives having small contraction coefficient. Non-limiting examples of the adhesive include epoxy adhesives, acrylic adhesives, cyanoacrylate adhesives, urethane adhesives, and hot melt adhesives.

The thermoplastic resin foam film and the multilayer foam film pertaining to the present invention are particularly preferably used as loudspeaker diaphragms. Specifically, these films are particularly suitably used as built-in loudspeaker diaphragms in portable terminals such as cell phones, smartphones, portable game machines, and tablet computers. In response to a request for higher sound volume in the market, a larger amount of current flows through the coils used in speakers, and thus generates a larger amount of heat in such portable terminals. The thermoplastic resin foam film and the multilayer foam film including the thermoplastic resin foam film pertaining to the present invention include the poly(meth)acrylimide resin in the foam film, thus have high heat resistance, and are usable in such portable terminals. The weight of a loudspeaker diaphragm is considered to directly affect acoustic characteristics. A lighter diaphragm readily vibrates and thus is considered to readily generate a higher sound volume. The thermoplastic resin foam film and the multilayer foam film including the thermoplastic resin foam film pertaining to the present invention have a predetermined average cell diameter and a density within a predetermined range, and thus readily achieve weight reduction. Due to such properties, a higher sound volume can also be easily achieved.

### EXAMPLES

The present invention will next be described in detail with reference to examples, but the present invention is not limited to the examples.

<Determination of Thickness of Foam Film>

With a thickness gauge, a sample with a size of 450 mm×300 mm was cut at 30 mm away from the peripheral edge of the sample. The thicknesses were measured at randomly selected 30 points, and the arithmetic mean was calculated as the average thickness. The difference between a maximum thickness and a minimum thickness was also calculated.

<Determination of Density of Foam Film>

The length, the width, and the weight of the sample after the determination of foam film thickness were determined. The volume was calculated from the length, the width, and the average thickness. The weight was divided by the volume to determine the density.

<Determination of Average Cell Diameter of Foam Film>

With apparatuses VHX-900 and VH-Z20R manufactured by KEYENCE, cell diameters were directly observed from the surface of a foam film (box-like foam when no film was prepared) through a 200× lens (RZ×20 to ×200). With a measurement tool attached to the apparatuses, five cells having a typical size were selected, and the distance between two points on each cell wall was determined. The intermediate value (average) of the maximum value and the minimum value of them was regarded as an average cell diameter.

It was ascertained that the cell diameter was not changed before and after the flattening.

<Appearance Evaluation of Flake During or after Cutting Step>

The appearance of a flake during or after the cutting step was visually observed.

### Examples 1 to 3

Box-like foams composed of a polymethacrylimide resin, ROHACELL (registered trademark) RC71RIST, RC71HF, and RC71RIMA (each having a size of 60 mm×90 mm×10 mm and a density of 71 kg/m³) manufactured by Daicel-Evonik Ltd. were used to be cut with the following cutting machine, where the target thickness was set to 0.30 mm (cutting step).

The cutting machine used has a frame capable of reciprocating on rails parallel with a floor. To the lower part of the frame, a foam is fixed. The foam is cut by reciprocation on a blade that is fixed so that the blade edge faces the foam side on an outward path or a return path. After every cutting, or every reciprocation, the foam moves down by a target cutting thickness, and thus the cutting machine performs successive cutting (see FIG. 1). The bias angle was set to 10°.

The cut flake was strongly curled and was a roll-like flake having a diameter of about 40 mm.

The roll-like flake obtained in the cutting step was interposed between two aluminum plates, and was heated in a hot air oven set at 110° C. for 10 minutes for flattening, yielding a thermoplastic resin foam film (flattening step).

Then, the film was allowed to cool, taken out, and subjected to each measurement. Table 1 shows the evaluation results. Each thermoplastic resin foam film had a density of 71 kg/m³, an average thickness of 0.30 mm, a difference between the maximum thickness and the minimum thickness of 0.03 mm, and an edge minimum thickness of 0.28 mm. The surface was smooth.

To both faces of the thermoplastic resin foam film obtained, aluminum foils having a thickness of 0.012 mm were attached with a two pack type epoxy resin adhesive (manufactured by Cemedine Co., Ltd., 1500), yielding a multilayer foam film having high rigidity. The multilayer foam film was lightweight, had high heat resistance and high rigidity, and should be used as a loudspeaker diaphragm.

### Examples 4 to 6

The same box-like foams as those in Examples 1 to 3 were used to be cut with the same cutting machine as that in Examples 1 to 3, where the target thickness was set to 0.20 mm, and the flattening was performed in the same manner as that in Examples 1 to 3. The thermoplastic resin foam films obtained by the flattening were subjected to the same measurements as those in Examples 1 to 3. Table 1 shows the evaluation results. Each thermoplastic resin foam film had an average thickness of 0.20 mm, a difference between the maximum thickness and the minimum thickness of 0.02 mm, and an edge minimum thickness of 0.19 mm. The surface was smooth.

Aluminum foils having a thickness of 0.012 mm were attached in the same manner as that in Examples 1 to 3, yielding a multilayer foam film having high rigidity. The multilayer foam film was lightweight, had high heat resistance and high rigidity, and should be used as a loudspeaker diaphragm.

### Example 7

A box-like foam composed of a polymethacrylimide resin, ROHACELL (registered trademark) RC110HP (having a size of 60 mm×90 mm×10 mm and a density of 110 kg/m³) manufactured by Daicel-Evonik Ltd. was used to be cut with the same cutting machine as that in Examples 1 to 3, where the target thickness was set to 0.30 mm, and the flattening was performed in the same manner as that in Examples 1 to 3. The thermoplastic resin foam film obtained by the flattening was subjected to the same measurements as those in Examples 1 to 3. Table 1 shows the evaluation results. The thermoplastic resin foam film had an average thickness of 0.30 mm, a difference between the maximum thickness and the minimum thickness of 0.02 mm, and an edge minimum thickness of 0.29 mm. The surface was smooth.

Aluminum foils having a thickness of 0.012 mm were attached in the same manner as that in Examples 1 to 3, yielding a multilayer foam film having high rigidity. The multilayer foam film was lightweight, had high heat resistance and high rigidity, and should be used as a loudspeaker diaphragm.

### Comparative Examples 1 to 5

Box-like foams composed of a polymethacrylimide resin, ROHACELL (registered trademark) RC71IG, RC71XT, RC71WF, RC71S, and RC71IG-F (each having a size of 60 mm×90 mm×10 mm and a density of 71 kg/m³) manufactured by Daicel-Evonik Ltd. were used to be cut with the same cutting machine as that in Examples 1 to 3, where the target thickness was set to 0.30 mm, but each was broken in the cutting step to yield no film-like product. Table 1 shows the evaluation results. In Table 1, the average cell diameters of Comparative Examples 1 to 5 were those of the box-like foams.

### Comparative Examples 6 and 7

Box-like foams composed of a polymethacrylimide resin, ROHACELL (registered trademark) RC51HF and RC51RIST (each having a size of 60 mm×90 mm×10 mm and a density of 51 kg/m³) manufactured by Daicel-Evonik Ltd. were used to be cut with the same cutting machine as that in Examples 1 to 3, where the target thickness was set to 0.30 mm, but each was broken in the cutting step not to yield good film-like products. Table 1 shows the evaluation results. In Table 1, the average cell diameters of Comparative Examples 6 and 7 were those of the box-like foams.

TABLE 1

| | Polymeth- | | Average cell | Average | |
|---|---|---|---|---|---|
| | acrylimide | Density | diameter | thickness | Flake appearance |
| | resin | [kg/m³] | [μm] | [mm] | and the like |
| Example 1 | RC71RIST | 71 | 200 | 0.30 | Uniform fine mesh |
| | | | | | sheet |
| Example 2 | RC71HF | 71 | 47.5 | 0.30 | Uniform ultrafine |
| | | | | | mesh sheet |
| Example 3 | RC71RIMA | 71 | 22.5 | 0.30 | Uniform sheet |
| Example 4 | RC71RIST | 71 | 200 | 0.20 | Uniform fine mesh |
| | | | | | sheet |
| Example 5 | RC71HF | 71 | 47.5 | 0.20 | Uniform ultrafine |
| | | | | | mesh sheet |
| Example 6 | RC71RIMA | 71 | 22.5 | 0.20 | Uniform sheet |
| Example 7 | RC110HP | 110 | 20 | 0.30 | Uniform sheet |
| Comparative | RC71IG | 71 | 395 | Unmeasurable | Brittle mesh sheet |
| Example 1 | | | | | |
| Comparative | RC71XT | 71 | 305 | Unmeasurable | Powdered |
| Example 2 | | | | | |
| Comparative | RC71WF | 71 | 825 | Unmeasurable | Powdered |
| Example 3 | | | | | |
| Comparative | RC71S | 71 | 340 | Unmeasurable | Powdered |
| Example 4 | | | | | |
| Comparative | RC71IG-F | 71 | 275 | Unmeasurable | Powdered |
| Example 5 | | | | | |
| Comparative | RC51HF | 51 | 50 | Unmeasurable | Many cracks |
| Example 6 | | | | | generated on |
| | | | | | cutting |
| Comparative | RC51RIST | 51 | 225 | Unmeasurable | Many cracks |
| Example 7 | | | | | generated on |
| | | | | | cutting |

### REFERENCE SIGNS LIST

1 Thermoplastic resin foam
2 Cutting machines
3 Cutting blade
4 Cutting table
5 Frame capable of feeding a predetermined amount of a foam
6 Fixing base
7 Leg
8 Pulley
9 Gripper
10 Adjuster

1. A thermoplastic resin foam film consisting substantially of a thermoplastic resin,
the thermoplastic resin being a poly(meth)acrylimide resin, the thermoplastic resin foam film having a density of 30 to 500 kg/m³, an average cell diameter of 2 to 500 μm, and a thickness of 0.05 to 1.0 mm.

2. A multilayer foam film produced by laminating an aluminum foil on at least one side of the thermoplastic resin foam film according to claim 1.

3. A loudspeaker diaphragm comprising the thermoplastic resin foam film according to claim 1 or the multilayer foam film according to claim 2.

4. A method for producing the thermoplastic resin foam film according to claim 1, the method comprising a cutting step of cutting a thermoplastic resin foam consisting substantially of a poly(meth)acrylimide resin with a cutting blade,
in the cutting step, at least one of the thermoplastic resin foam and the cutting blade being reciprocated, the thermoplastic resin foam sliding on the cutting blade on at least one path of an outward path and a return path, thus the thermoplastic resin foam being intermittently cut to yield a flake consisting substantially of the poly(meth)acrylimide resin.

5. The method for producing the thermoplastic resin foam film according to claim 4, the method further comprising a flattening step of flattening the flake while the flake is heated at a temperature [° C.] that is not lower than a temperature 100 [° C.] lower than a glass transition temperature (Tg) [° C.] of the poly(meth)acrylimide resin and is not higher than the Tg.
